(19) United States
(12) Patent Application Publication
(10) Pub. No.: US 2015/0269510 A1
(43) Pub. Date: Sep. 24, 2015

(54) WORKLOAD DETERMINATION FOR INFORMATION TECHNOLOGY SERVICE EVENTS

(71) Applicant: International Business Machines Corporation, Armonk, NY (US)

(72) Inventors: Tomas Mazzo de Oliveira Campos, Vinhedo (BR); Adan Rosler, Campinas (BR)

(73) Assignee: International Business Machines Corporation, Armonk, NY (US)

(21) Appl. No.: 14/220,822

(22) Filed: Mar. 20, 2014

(51) Int. Cl. G06Q 10/06

(52) U.S. Cl. CPC G06Q 10/06312; G06Q 10/0633

(57) ABSTRACT

A tool for determining a third workload for a plurality of service events. The tool determines, by one or more computer processors, service event metadata for one or more service events in the plurality of service events. The tool assigns, by one or more computer processors, a complexity level to the one or more service events in the plurality of service events. The tool assigns, by one or more computer processors, a first event workload for the one or more service events in the plurality of service events to time slots. The tool determines, by one or more computer processors, based, at least in part, on the service event metadata, the complexity level, and the first event workload for the one or more service events in the plurality of service events, a third event workload for the one or more time slots in a plurality of time slots.

### FIELD OF THE INVENTION

The present invention relates generally to information technology, and more particularly to determining workload created by service events.

### BACKGROUND OF THE INVENTION

Informational systems utilized in business environments have experienced an increase in complexity relating to components (e.g., servers and applications), and structural connectivity. Often, business success depends heavily on the health of these informational systems, and as such, many businesses employ specialized analyst teams dedicated to monitoring these environments to ensure smooth operation of system components.

Most information technology (IT) companies utilize the full-time equivalent (FTE) method to measure analyst involvement in service delivered. For example, 1 FTE indicates that a given analyst is equivalent to a full-time worker, whereas 0.5 FTE indicates that a given analyst is equivalent to a half-time worker. The number of FTEs (i.e., analysts) available must match the workload volume in a way that ensures response time is sufficient to avoid service level agreement infringement, and also limit costly and unnecessary idle time.

With higher competition in IT service areas, companies are required to increase productivity and cost savings by increasing the number of customers served while simultaneously reducing the number of analysts serving these customers. Workload studies and defect prevention programs and initiatives are being developed in order to increase service quality, as well as find ways to reduce workload and optimize analyst team productivity. Most companies estimate the average time taken by an analyst to perform a service event. When one or more IT service events are eliminated through one of these initiatives, FTEs can be reduced, or new customers can be added to the service base, thereby maximizing the company's profit per employee. For example, if a service event requiring some form of service action previously executed in an average of 30 minutes is eliminated, then the amount of FTEs is reduced 30 minutes (a typical FTE represents 8 hours of worked hours). FTE savings can be translated into reduced workload for an analyst team, or replaced with new customer service requests.

### SUMMARY

Aspects of the present invention disclose a method, system, and computer program product for determining a workload for a plurality of service events. The method includes determining, by one or more computer processors, service event metadata for one or more service events in the plurality of service events. The method includes assigning, by one or more computer processors, a complexity level to the one or more service events in the plurality of service events. The method includes assigning, by one or more computer processors, a first event workload for the one or more service events in the plurality of service events to time slots. The method includes determining, by one or more computer processors, based, at least in part, on the service event metadata, the complexity level, and the first event workload for the one or more service events in the plurality of service events, a third event workload for the one or more time slots in the plurality of time slots.

### BRIEF DESCRIPTION OF THE SEVERAL DRAWINGS

FIG. 1 is a functional block diagram illustrating a data processing environment, generally designated 100, in accordance with an embodiment of the present invention.

FIG. 2 is a flowchart of an exemplary process flow, generally designated 200, for determining a third event workload and an index for a plurality of service events, in accordance with an embodiment of the present invention.

FIG. 3 is a block diagram depicting components of a server computer (such as the server of FIG. 1), in accordance with an embodiment of the present invention

### DETAILED DESCRIPTION

Embodiments of the present invention recognize that current workload estimation methods are too simplistic and do not consider the number of service events executed concurrently by an analyst.

Embodiments of the present invention provide the capability to determine a workload profile, which can identify cost saving opportunities and work reduction opportunities, by considering multiple service events executed concurrently by an analyst, and the complexity of each service event executed by the analyst, to obtain more refined and meaningful data for determining productivity bottlenecks and opportunities to reduce workload.

Implementation of such embodiments may take a variety of forms, and exemplary implementation details are discussed subsequently with reference to the Figures.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

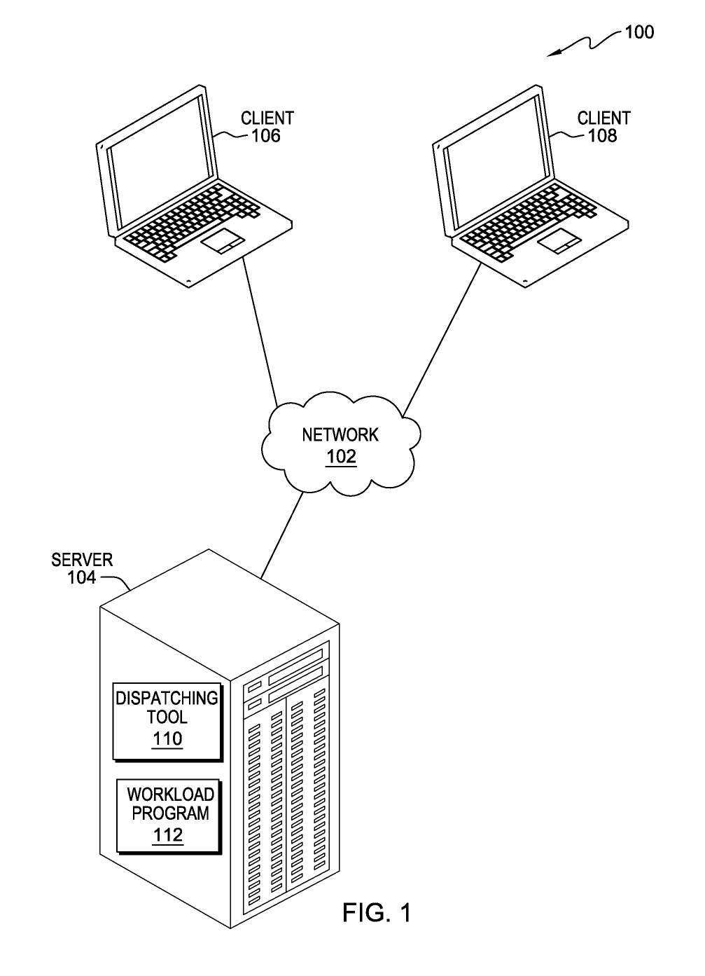

The present invention will now be described in detail with reference to Figures. FIG. 1 illustrates a data processing environment, generally designated 100, according to an exemplary embodiment of the present invention. Data processing environment 100 comprises network 102, server 104, and multiple client computers, such as client 106 and client 108, in accordance with an exemplary embodiment of the present invention.

In the exemplary embodiment, network 102 is the Internet representing a worldwide collection of networks and gateways that use TCP/IP protocols to communicate with one another. Network 102 may include wire cables, wireless communication links, fiber optic cables, routers, switches and/or firewalls. Server 104 and client computers 106 and 108 are interconnected by network 102. Network 102 can be any combination of connections and protocols capable of supporting communications between server 104, client 106, client 108, and dispatching tool 110. Network 102 may also be implemented as a number of different types of networks, such as an intranet, a local area network (LAN), a virtual local area network (VLAN), a wide area network (WAN), or any combination of a number of different types. FIG. 1 is intended as an example, and not as an architectural limitation for the different embodiments.

In the exemplary embodiment, server 104 may be, for example, a server computer system such as a management server, a web server, or any other electronic device or computing system capable of sending and receiving data. In another embodiment, server 104 represents a “cloud” of computers interconnected by one or more networks, where server 104 is a computing system utilizing clustered computers and components to act as a single pool of seamless resources when accessed through network 102. This is a common implementation for data centers in addition to cloud computing applications. In the exemplary embodiment, server 104 includes dispatching tool 110 and workload program 112 for determining a workload profile.

In the exemplary embodiment, clients 106 and 108 are clients to server 104, and may be, for example, a notebook, laptop computer, tablet computer, a personal digital assistant (PDA), a smart phone, a thin client, or any other electronic device or computing system capable of communicating with server 104 through network 102. Clients 106 and 108 include a processor (not shown) and one or more data storage devices (not shown). The processor can be any custom made or commercially available processor, a central processing unit (CPU), an auxiliary processor among several processors associated with the computer, a semiconductor based microprocessor, a macro processor, or generally any device capable of executing instructions. The one or more data storage devices can be at least one of the random access memory (RAM), read only memory (ROM), a cache, a stack, or the like that can temporarily or permanently store electronic data.

In the exemplary embodiment, dispatching tool 110 is a monitoring tool utilized in IT technical operations and support environments. Dispatching tool 110, in response to receiving a plurality of service events (i.e., events related to system and application error messages, customer requests, tickets, periodical maintenances, and any other type of IT events) from one or more clients, such as client 106 and client 108, sends the service events to one or more analysts for execution. In the exemplary embodiment, dispatching tool 110 collects service event metadata, such as start and end dates and times of service events, duration of service events, complexity of service events, etc., which can be utilized to help determine a workload profile. Dispatching tool 110 may be fully integrated, partially integrated, or separate from server 104.

In the exemplary embodiment, workload program 112 includes a plurality of program and functions to determine a workload profile for one or more analysts. The workload profile serves to identify generally improved methods for IT servicing, including, but not limited to, productivity bottlenecks and real cost saving opportunities. Workload program 112 determines an average worked time for service events that considers concurrently executed service events, as well as complexity of concurrently executed service events.

Data processing environment 100 may include additional server computers, client computers, displays and other devices not shown.

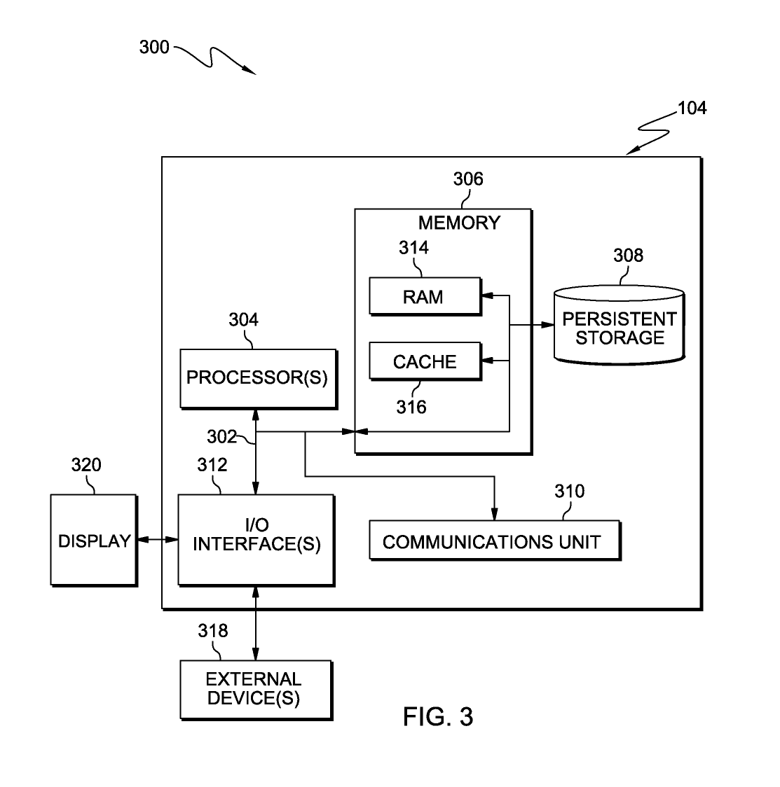

Server 104 and clients 106 and 108, each maintain respective internal components, and respective external components. In general, server 104 can be any programmable electronic device as described in further detail with respect to FIG. 3.

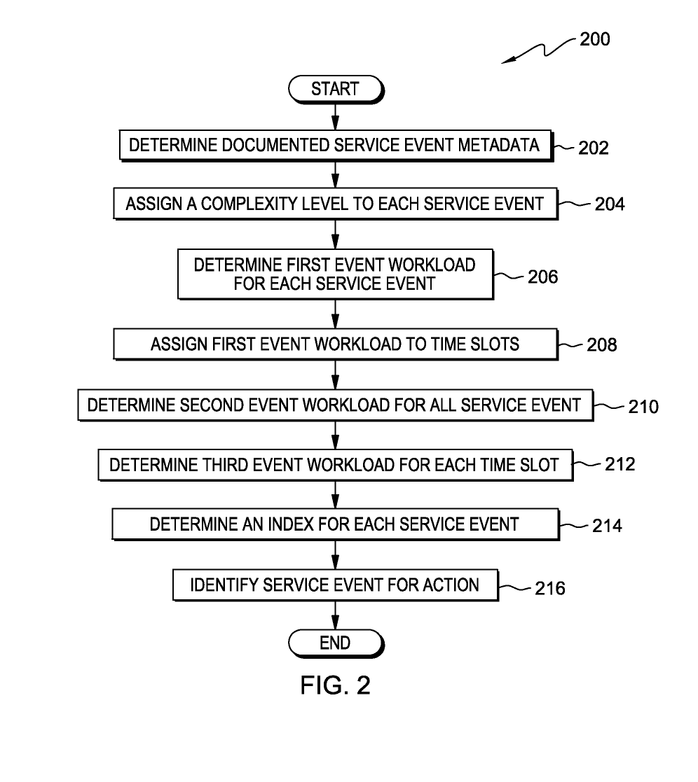

FIG. 2 is a flowchart depicting the steps of workload program 112 for determining a third event workload and an index for a plurality of service events, in accordance with an embodiment of the present invention.

Workload program 112 determines documented service event metadata (step 202). In the exemplary embodiment, workload program 112 determines documented service event metadata by requesting documented service event metadata from dispatching tool 110. Workload program 112 determines the plurality of service events slated for processing by an analyst, and collects metadata for each service event in the plurality of service events. Workload program 112 determines, based, at least in part, on the documented service event metadata, the plurality of service events to be executed by an analyst, the number of concurrent service events to be executed by the analyst, the start data and time of each service event, the end data and time of each service event, and the complexity of each service event, as well as analyst workload capacity for a specific timeframe, analyst workload capacity consumed by each service event, team workload capacity for a specific timeframe, and impact on team workload capacity for each service event. For example, suppose that a given team includes an analyst that starts working on a first level 3 complexity service event (i.e., a level 3 complexity on a scale from 1-3, where 1 indicates a relatively simple service event, and 3 indicates a highly complex service event), at a start time of T=0 minutes. After 30 minutes, while still working on the first service event, the analyst is assigned a second level 1 complexity service event. After 10 minutes from being assigned the second service event, while working on the first and second service event, the analyst is assigned a third level 2 complexity service event. Within 20 minutes from receiving the third service event, the analyst completes the second service event. Another 20 minutes from completing the second service event, the analyst completes the third service event. Finally, after 20 minutes from completing the third service event, the analyst, at T=100 minutes, completes the first service event. In the foregoing example, workload program 112 can determine that the analyst worked a total time of 100 minutes on three different service events, with each service event varying in complexity, determining the start and end times for the three different service events.

In response to determining documented service event metadata, workload program 112 assigns a complexity level to each service event in a plurality of service events (step 204). In the exemplary embodiment, workload program 112 assigns a complexity level to each service event in a plurality of service events that accurately reflects the varying complexity of different service events, based, at least in part on, an individual analyst assessment, historical data on how long similar service events have taken to complete in the past, and how detailed or interconnected a service event may be with components and devices in the environment. Different service events have different levels of complexity, where the more complex a service event is, the more time an attention the service event demands. Different complexity levels may be correlated into different weighted values to indicate the amount of attention the service event demands. For example, three complexity levels may be used for illustrating the varying complexities of service events. A simple service event, one demanding below average attention, may be assigned a weighted value of 1. A medium service event, one demanding average attention, may be assigned a weighted value of 2. A complex service event, one demanding above attention, may be assigned a weighted value of 3. As will be forthcoming, these weighted values will be used in calculating a final workload for each service event.

In response to assigning a complexity level to each service event in a plurality of service events, workload program 112 determines a first event workload for each service event in a plurality of service events (step 206). In the exemplary embodiment, workload program 112 determines the first event workload for one or more service events in a plurality of service events by calculating the first event workload as time spent on a specific service event proportional to the complexity level of the specific service event, and the number of concurrent events executed by a specific analyst. In the exemplary embodiment, workload program 112 determines the first event workload according to an equation defined by the principle of event monitoring: W=E₁+E₂+E₃ . . . Eₙ=ΣⁿEᵢ for i=1 to n, where W represents the first event workload measured in time generated by each service event in a plurality of service events in a range from E₁ to Eₙ, where E represents the first event workload measured in time generated by an individual service event.

In response to determining the first event workload for the one or more service events in the plurality of service events, workload program 112 assigns the first event workload(s) to time slots (step 208). In the exemplary embodiment, workload program 112 assigns a portion of the first event workload for a specific service event to a time slot. Time slots segment the service events in a plurality of service events consecutively every time a service event begins, or any time a service event ends, to define a total time worked for a specific service event by respective time slots associated with the specific event. For example, suppose that a given support team includes an analyst that starts working on a first service event (E₁), with a complexity level of 3 (C₃), at time 0 minutes (T=0). After 30 minutes, while still working on the first service event, the analyst begins working on a second service event (E₂), with a complexity level of 1 (C₁), at time 30minutes (T=30). After 10 minutes, the analyst begins working on a third service event (E₃), with a complexity level of 2 (C₂), at time 40 minutes (T=40). Within 20 minutes, the analyst finishes work on the second service event, ending at time 60 minutes (T=60), and in 20 more minutes the analyst finishes work on the third service event, ending at time 80 minutes (T=80). Finally, after 20 more minutes, the analyst finishes work on the first service event, ending at time 100 minutes (T=100). In this scenario, the analyst worked a total time of 100 minutes on three different service events, each service event having a different complexity level. To more accurately determine the real workload generated by each service event, the fact that several service events were worked on concurrently, as well as their varying complexity levels are considered. In the exemplary embodiment, workload program 112 divides each service event into several time slots (S). A time slot begins and ends every time an additional event also begins and ends. By dividing each service event into time slots, the service event workload becomes defined by its corresponding time slots, and no longer only by its original duration (i.e., start time to end time). For example, referencing the above scenario, concurrent service events E₁, E₂, and E₃ may be divided into time slots S1, S2, S3, S4, and S5, where time slot S1 represents the time between when service event E₁ began and service event E₂ began, time slot S2 represents the time between when service event E₂ began and when service event E₃ began, time slot S3 represents the time between when service event E₃ began and service event E₂ ended, time slot S4 represents the time between when service event E₂ ended and service event E₃ ended, and time slot S5 represents the time between when service event E₃ ended and service event E₁ ended. In the exemplary embodiment, time slots, such as S1-S5, can be expressed in a table, where each row represents a service event, such as E₁, and each column represents the corresponding time slot(s), such as S1-S5. Naming the row and column for each variable S, according to its position in the table, can be expressed as Sᵢⱼ, where index i represents the row of the table, and index j represents the column. For example, the time slots corresponding to service event E₂ may be expressed as S₂₂ and S₃₂, and the time slots corresponding to service event E₃ may be expressed as S₃₃ and S₄₃.

In response to assigning the first event workload to time slots, workload program 112 determines a second event workload for the plurality of service events (step 210). In the exemplary embodiment, workload program 112 determines the second event workload for the plurality of service events using an expression defined as ΣⁿΣ^{m}Sᵢⱼ for i=1 to n, and j=1 to m, where i represents a number of a time slot row in a range from 1 to n, and j represents a number of a time slot column in a range from 1 to m. Using this expression, it can be concluded that the second event workload will be represented by the summation of all time slots, whose values vary according to the number and complexity of concurrent service events in progress.

In response to determining the second event workload for the plurality of service events, workload program 112 determines a third event workload for a specific time slot in a plurality of time slots (step 212). In the exemplary embodiment, workload program 112 determines the third event workload for a specific time slot in a plurality of time slots by representing the third event workload for a specific time slot through an expression defined as Sᵢⱼ=Δt_{Sij}*(C_{Ei}/Σⱼ₌₁C_{Sij}i), where Sᵢⱼ represents a time slot, Δt_{Sij} represents a difference in time between a start and an end of the time slot, C_{Ei} represents the complexity level of service event i, and Σⱼ₌₁C_{Sij}i represents a summation of complexities for all service events worked concurrently in time slot j. The sum of all time slots is equal to a real worked time, from the beginning of a first service event to the end of a last service event. A relationship between real worked time, service event complexity (i.e., complexity level), and number of concurrent service events in progress yields the third event workload for each specific service event. For example, using the above referenced scenario, resolving the equation for the second time slot (i.e., S₂₁, the time slot where E₂ began) for E₂ yields a value of 2.5, and resolving the equation for the third time slot (i.e., S₂₂, the time slot where E₂ ends) for E₂ yields a value of 3.33. Solving for all time slots for all events shows that the sum of all time slots equals the third event workload (i.e. real worked time in the above scenario, T=100 minutes), from the beginning of the first event until the end of the last event. For example, in the above referenced scenario, the third event workload per event, in minutes, is: E₁=79.5, E₂=5.83, and E₃=14.67. The sum of all service events is 100 minutes, which accurately reflects the time the analyst spent working on service events E₁, E₂, and E₃.

In response to determining the third event workload for a specific time slot, workload program 112 determines an index for each service event in a plurality of service events (step 214). In the exemplary embodiment, workload program 112 determines the index for each service event in a plurality of service events using an expression of I=(WE*WD²)/C², where WE represents a measured workload of a specific service event, WD represents a workload for a predefined period of time, and C represents a team capacity for absorbing and processing work (i.e. service events), in a period of measured time (e.g., day, week, month, etc.). The greater the value of I, the greater the priority of the service event with respect to generating workload reduction and highlighting areas of opportunity, as it represents a situation where fewer available analysts in the team receive the total amount of workload during a period of measured time. For example, suppose the following scenario: an IT team possesses a staff of 16 analysts with a work schedule such that the staff availability is 75% of full from Monday to Thursday, 100% on Friday, and 50% on Saturday and Sunday, and the typical work day is an 8 hour shift. It follows that the average worked hours for the team is 94 hours on Monday, Tuesday, Wednesday, and Thursday, 126 hours on Friday, and 62 hours on Saturday and Sunday. On Friday, the team receives event A, with a corresponding workload of 8 hours. On Friday the team capacity of work is 126 hours, and the total workload for the day is 35 hours. Resolving for I using these values yields an index of 0.62. However, on Saturday the team receives event B, with a corresponding workload of 5 hours. On Saturday the team capacity of work is 62 hours, and the total workload for the day is 40 hours. Resolving for I using these values yields an index of 2.08.

In response to determining the index for the one or more service events, workload program 112 identifies one or more target service events for action (step 216). In the exemplary embodiment, workload program 112 identifies one or more target events for action, such as delegation of service events to analysts with less total workload, days with less total workload, or elimination of service events, using a ranked index associated with the target events. The ranked priority of the particular service event as it relates to generating workload reduction, improving efficiency, cost savings, and opportunities of real productivity is proportional to the index. For example, in the above referenced scenario, considering the team capacity of work and the workload of the day for Saturday, that event with the greatest impact to the team is event B, with an index of 2.08 over event A's index of 0.62. Even with the lower value of the event workload, the fact that the event comes on a day with reduced team capacity and higher workload of the day, establishes priority for event B over the other service events.

FIG. 3 depicts a block diagram of components of server 104, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server 104 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications, network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Dispatching tool 110 and workload program 112 can be stored in persistent storage 308 for execution by one or more of the respective computer processor(s) 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including clients 106 and 108. In these examples, communications unit 310 includes one or more network interface cards. Communications unit 310 may provide communications through the use of either or both physical and wireless communications links. Dispatching tool 110 and workload program 112 may be downloaded to persistent storage 308 through communications unit 310.

I/O interface(s) 312 allows for input and output of data with other devices that may be connected to server 104. For example, I/O interface(s) 312 may provide a connection to external device(s) 318 such as a keyboard, a keypad, a touch screen, and/or some other suitable input device. External device(s) 318 can also include portable computer-readable storage media such as, for example, thumb drives, portable optical or magnetic disks, and memory cards. Software and data used to practice embodiments of the present invention, e.g., dispatching tool 110 and workload program 112, can be stored on such portable computer-readable storage media and can be loaded onto persistent storage 308 via I/O interface(s) 312. I/O interface(s) 312 also connects to display 320.

Display 320 provides a mechanism to display data to a user and may be, for example, a computer monitor.

The programs described herein are identified based upon the application for which they are implemented in a specific embodiment of the invention. The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a,” “an,” and “the” are intended to include the plural forms as well, unless the context clearly indicates otherwise.

The description of the present invention has been presented for purposes of illustration and description, but is not intended to be exhaustive or limited to the invention in the form disclosed. Many modifications and variations will be apparent to persons of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining a workload for a plurality of service events, the method comprising:
determining, by one or more computer processors, service event metadata for one or more service events in the plurality of service events;
assigning, by one or more computer processors, a complexity level to the one or more service events in the plurality of service events;
assigning, by one or more computer processors, a first event workload for the one or more service events in the plurality of service events to a plurality of time slots; and
determining, by one or more computer processors, based, at least in part, on the service event metadata, the complexity level, and the first event workload for the one or more service events in the plurality of service events, a third event workload for one or more time slots in the plurality of time slots.

2. The method of claim 1, further comprising:
determining, by one or more computer processors, based, at least in part, on the third event workload for the one or more time slots in the plurality of time slots, an index for one or more service events in the plurality of service events; and
identifying, by one or more computer processors, based, at least in part, on the index, target service events.

3. The method of claim 1, wherein determining service event metadata for one or more service events in the plurality of service events, further comprises determining one or more of:
a plurality of service events to be completed;
a number of concurrent service events executed by an analyst;
the complexity level for the one or more service events in the plurality of service events. the one or more service event start times;
the one or more service event end times;
an analyst event workload capacity; and
a team event workload capacity for a predefined period of time.

4. The method of claim 1, wherein assigning a complexity level to the one or more service events in the plurality of service events, further comprises determining the complexity level for the one or more service events in the plurality of service events, based, at least in part, on one or more of the following:
an analyst assessment;
historical data on a time to complete similar service events;
a level of detail involved in the one or more service events; and
a level of interconnection between the one or more service events and other components in the environment.

5. The method of claim 1, wherein assigning the first event workload for the one or more service events in the plurality of service events to the plurality of time slots, further comprises:
determining, by one or more computer processors, based, at least in part, on the complexity level for the one or more service events and the number of concurrent service events executed by an analyst, the first event workload for the one or more service events in the plurality of service events, wherein the first event workload is expressed as time spent on a specific service event proportional to the complexity level of the specific service event and the number of concurrent service events executed by the analyst.

6. The method of claim 1, wherein assigning the first event workload for the one or more service events in the plurality of service events to the plurality time slots, further comprises assigning a portion of the first event workload for the one or more service events to the one or more time slots, wherein the one or more service events are consecutively segmented each time the one or more service events begins and each time the one or more service events ends.

7. The method of claim 1, wherein determining the third event workload for the one or more time slots in the plurality of time slots, further comprises determining a second event workload for the plurality of time slots, based at least in part, on, a summation of the plurality of time slots, wherein values for the plurality of time slots vary according to a number and the complexity level of concurrent service events in progress.

8. The method of claim 1, wherein determining the third event workload for the one or more time slots in the plurality of time slots, further comprises determining a relationship between a specific time slot, the complexity level of the one or more service events, and a summation of the complexity levels for the plurality of service events concurrently in the specific time slot.

9. The method of claim 2, wherein determining the index for the one or more service events in the plurality of service events, further comprises determining a relationship between a workload of a specific service event, a workload for a predefined period of time, and a team capacity for managing the one or more service events in a period of time.

10. The method of claim 2, wherein identifying target service events, further comprises determining a ranked index associated with target service events based, at least in part, on a correlation between the index for the one or more service events and workload reduction, wherein the ranked index as relates to generating workload reduction is proportional to the index.

11. A computer program product for determining a workload for a plurality of service events, the computer program product comprising:
one or more computer-readable storage media and program instructions stored on the one or more computer-readable storage media, the program instructions comprising:
program instructions to determine, by one or more computer processors, service event metadata for one or more service events in the plurality of service events;
program instructions to assign, by one or more computer processors, a complexity level to the one or more service events in the plurality of service events;
program instructions to assign, by one or more computer processors, a first event workload for the one or more service events in the plurality of service events to a plurality of time slots; and
program instructions to determine, by one or more computer processors, based, at least in part, on the service event metadata, the complexity level, and the first event workload for the one or more service events in the plurality of service events, a third event workload for one or more time slots in the plurality of time slots.

12. The computer program product of claim 11, further comprising:
program instructions to determine, by one or more computer processors, based, at least in part, on the third event workload for the one or more time slots in the plurality of time slots, an index for one or more service events in the plurality of service events; and
program instructions to identify, by one or more computer processors, based, at least in part, on the index, target service events.

13. The computer program product of claim 11, wherein program instructions to determine service event metadata for one or more service events in the plurality of service events, further comprises program instructions to determine one or more of:
a plurality of service events to be completed;
a number of concurrent service events executed by an analyst;
the complexity level for the one or more service events in the plurality of service events. the one or more service event start times;
the one or more service event end times;
an analyst event workload capacity; and
a team event workload capacity for a predefined period of time.

14. The computer program product of claim 11, wherein program instructions to assign a complexity level to the one or more service events in the plurality of service events, further comprises program instructions to determine the complexity level for the one or more service events in the plurality of service events, based, at least in part, on one or more of the following:
an analyst assessment;
historical data on a time to complete similar service events;
a level of detail involved in the one or more service events; and
a level of interconnection between the one or more service events and other components in the environment.

15. The computer program product of claim 11, wherein program instructions to assign the first event workload for the one or more service events in the plurality of service events to the plurality of time slots, further comprises:
program instructions to determine, by one or more computer processors, based, at least in part, on the complexity level for the one or more service events and the number of concurrent service events executed by an analyst, the first event workload for the one or more service events in the plurality of service events, wherein the first event workload is expressed as time spent on a specific service event proportional to the complexity level of the specific service event and the number of concurrent service events executed by the analyst.

16. A computer system for determining a workload for a plurality of service events, the computer system comprising:
one or more computer processors;
one or more computer-readable storage media;
program instructions stored on at least one of the one or more computer-readable storage media for execution by at least one of the one or more computer processors, the program instructions comprising:
program instructions to determine, by one or more computer processors, service event metadata for one or more service events in the plurality of service events;
program instructions to assign, by one or more computer processors, a complexity level to the one or more service events in the plurality of service events;
program instructions to assign, by one or more computer processors, a first event workload for the one or more service events in the plurality of service events to a plurality of time slots; and
program instructions to determine, by one or more computer processors, based, at least in part, on the service event metadata, the complexity level, and the first event workload for the one or more service events in the plurality of service events, a third event workload for one or more time slots in the plurality of time slots.

17. The computer system of claim 16, wherein program instructions to assign the first event workload for the one or more service events in the plurality of service events to the plurality time slots, further comprises program instructions to assign a portion of the first event workload for the one or more service events to the one or more time slots, wherein the one or more service events are consecutively segmented each time the one or more service events begins and each time the one or more service events ends.

18. The computer system of claim 16, wherein program instructions to determine the third event workload for the one or more time slots in the plurality of time slots, further comprises program instructions to determine a second event workload for the plurality of time slots, based at least in part, on, a summation of the plurality of time slots, wherein values for the plurality of time slots vary according to a number and the complexity level of concurrent service events in progress.

19. The computer system of claim 16, wherein program instructions to determine the third event workload for the one or more time slots in the plurality of time slots, further comprises program instructions to determine a relationship between a specific time slot, the complexity level of the one or more service events, and a summation of the complexity levels for the plurality of service events concurrently in the specific time slot.

20. The computer system of claim 16, further comprising:
program instructions to determine, by one or more computer processors, based, at least in part, on the third event workload for the one or more time slots in the plurality of time slots, an index for one or more service events in the plurality of service events; and
program instructions to identify, by one or more computer processors, based, at least in part, on the index, target service events.
